(19) United States
(12) Patent Application Publication
(10) Pub. No.: US 2022/0201990 A1
(43) Pub. Date: Jun. 30, 2022

(54) DEVICE FOR CULTIVATING FISH LARVAE AND METHOD FOR CONSTRUCTING THE DEVICE

(71) Applicants: Suzhou Fish Seeds Bio-Tech., LTD, Suzhou (CN); Hongze Fish Seeds Bio-Tech., LTD, Huai'an (CN)

(72) Inventors: Qinghua LIU, Suzhou (CN); Jia DU, Suzhou (CN); Yuhong ZHENG, Suzhou (CN); Han MENG, Suzhou (CN); Naomi SUDO, Suzhou (CN)

(21) Appl. No.: 17/517,654

(22) Filed: Nov. 2, 2021

Related U.S. Application Data
(63) Continuation-in-part of application No. PCT/CN2021/090612, filed on Apr. 28, 2021.

(30) Foreign Application Priority Data
Dec. 30, 2020 (CN) 202011643271.0

(51) Int. Cl. A01K 63/04; A01K 61/10; A01K 63/00

(52) U.S. Cl. CPC A01K 63/045; A01K 61/10; A01K 63/042; A01K 63/047; A01K 63/003

(57) ABSTRACT

A device for high density culture of fish larvae includes: a nursery tank, a first aerotube, a standing mesh drain pipe, and a dual-drain recirculating water treatment system. The nursery tank is a rounded corner tank or a polygonal tank without dead corners. The first aerotube is disposed around the bottom of the inner wall of the nursery tank. The standing mesh drain pipe is disposed in the center of the bottom of the nursery tank. The dual-drain recirculating water treatment system includes a first water treatment system and a second water treatment system. The first water treatment system and the second water treatment system are symmetrically disposed on both sides of the nursery tank, respectively. The first water treatment system is configured to purify upper layer water of the nursery tank, and the second water treatment system is configured to purify lower layer water of the nursery tank.

### CROSS-REFERENCE TO RELAYED APPLICATIONS

This application is a continuation-in-part of International Patent Application No. PCT/CN2021/090612 with an international filing date of Apr. 28, 2021, designating the United States, now pending, and further claims foreign priority benefits to Chinese Patent Application No. 202011643271.0 filed Dec. 30, 2020. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to the aquaculture, and more particularly to, a device for cultivating fish larvae with high density and a method for constructing the same.

Fish larvae culture has always been a bottleneck in the aquaculture industry around the world, especially for vulnerable species, including American shad (Alosa sapidissima) and American crappie (Pomoxis spp.).

Currently, fish larvae are mainly cultured in outdoor ponds or indoor cement ponds for most species. The larval growth in the outdoor ponds is closely associated with weather. Fish larvae, which are in the critical developmental period for their growth and metamorphosis into fish juveniles, are extremely sensitive or vulnerable to changes in the external environment and water quality. For example, unstable weather changes of the larval culture environment may directly lead to the death of fish larvae due to too low or too high temperature. In addition, the weather may lead to the deterioration of the water quality, causing the environmental pollution, which induces the physiological stress responses of fish larvae, which results in the frailty of bodily constitution or deaths of the larvae.

Although conventional indoor culture of larvae fish in cement tanks is less affected by the weather, the fish tank structure and accessary facilities are not professionally designed based on the biological characteristics and living behavior of fish larvae, but only on account of the influence of the weather, especially the temperature, on the fish larvae and food supply. Thus, the comprehensive effects of the biological and non-biological factors on the development of fish larvae are not considered. Owing to the unreasonable fish pond structure, water flow and aeration, and lack of water purification treatment facilities, a large amount of sewage water is accumulated, which interferes with the micro-ecological environment for the development of fish larvae. Thus, it is difficult to ensure a stable environment for the probiotic flora and sustainable high-quality water for larvae growth in conventional indoor larval culture system. For example, the ammonia nitrogen and nitrite will increase without water treatment, which results in deteriorated water quality and poses a hazard to the fish larvae. Studies have shown that, in the early stage of the development of shad larvae, even if the nitrite content is low (<0.08), it is poisonous to fish larvae, and the deformity rate of fish larvae is significantly increased. The deterioration of water quality will also trigger physiological stress response, endanger the health, decrease the survival rate, and inhibit the growth of shad larvae.

### SUMMARY

The disclosure provides a device for high density culture of fish larvae, the device comprising a nursery tank comprising an inner wall, a first aerotube mounted on the inner wall, a standing mesh drain-pipe, and a dual-drain recirculating water treatment system. The nursery tank is a rounded corner tank or a polygonal tank without dead corners; the aerotube is mounted around a bottom of the inner wall of the nursery tank; the standing mesh drain pipe is disposed in a center of a bottom of the nursery tank; the dual-drain recirculating water treatment system comprises a first water treatment system and a second water treatment system, which are symmetrically disposed on both sides of the nursery tank, respectively; the standing mesh drain-pipe communicates with the second water treatment system; and when in use, the first water treatment system is configured to purify upper layer water of the nursery tank, and the second water treatment system is configured to purify lower layer water of the nursery tank.

In a class of this embodiment, the first water treatment system comprises a first drain window disposed at an upper part of a wall of the nursery tank, a first filter net cage, a first filtering basin, a first biological filtering basin, a first water reservoir, and a first airlift pump comprising a first water outlet; the upper layer water of the nursery tank passes through the first drain window, is purified by the first filter net cage, the first filtering basin, and the first biological filtering basin successively, and is stored in the first water reservoir; the first airlift pump is disposed in the first water reservoir; the first water reservoir communicates with the nursery tank through the first airlift pump and the first water outlet.

In a class of this embodiment, the second water treatment system comprises a second drain window disposed at a lower part of the wall of the nursery tank, a second filter net cage, a second filtering basin, a second biological filtering basin, a second water reservoir, and a second airlift pump comprising a second water outlet; the lower layer water of the nursery tank passes through the standing mesh drain pipe and the second drain window, is purified by the second filter net cage, the second filtering basin, and the second biological filtering basin successively, and is stored in the second water reservoir; the second airlift pump is disposed in the second water reservoir; the second water reservoir communicates with the bottom of the nursery tank through the second airlift pump and the second water outlet.

In a class of this embodiment, the first biological filtering basin comprises a second aerotube disposed along a flow direction of the upper layer water and a first biological filtration brush connected to the second aerotube; and/or the second biological filtering basin comprises a third aerotube disposed along a flow direction of the lower layer water and a second biological filtration brush connected to the third aerotube.

In a class of this embodiment, the first filter net cage comprises a screen of 50 to 80 meshes; and/or, the second filter net cage comprises a screen of 50 to 80 meshes.

In a class of this embodiment, the first airlift pump is a first nano-tubular airlift pump disposed below the liquid level of the first water reservoir, and/or the second airlift pump is a second nano-tubular airlift pump disposed below the liquid level of the second water reservoir.

In a class of this embodiment, the first/second nano-tubular airlift pump comprises a first polyvinyl chloride (PVC) tube and a fourth aerotube disposed inside the first PVC tube; one end of the fourth aerotube is blocked; and the other end of the fourth aerotube is connected to an air tube equipped with a valve and being connected to a blower.

In a class of this embodiment, the length of the fourth aerotube is in the range of 200 to 800 mm; and/or,

The inner diameter of the first PVC tube is in the range of 60 to 100 mm.

In a class of this embodiment, the standing mesh drain pipe comprises a second PVC tube and a central filter screen covering the nozzle of the second PVC tube, and the central filter screen is in the range of 40 to 80 meshes.

In a class of this embodiment, the device for high-density culture of fish larvae further comprises a discharge port communicating with the nursery tank.

In a class of this embodiment, the nursery tank has an area of 10 to 50 m², and contains water in a depth of 0.8 to 1.5 m.

The disclosure further provides a method for constructing the device for high-density culture of fish larvae, comprising:

1) building the nursery tank, the nursery tank comprising a nano-microbubble flow steam curtain and configured for suspension growth of fish larvae and probiotics;

2) building a dual-drain recirculating water treatment system, the dual-drain recirculating water treatment system comprises the first water treatment system and the second water treatment system disposed on both sides of the nursery tank.

In a class of this embodiment, in 1), building the nursery tank comprises the following steps:

1.1) choosing a rounded corner tank or a polygonal tank without right angles as the nursery tank, the nursery tank has an area of 10-50 m², and the nursery tank contains water in a depth range of 0.8-1.5 m;

1.2) disposing a second drain window on the bottom of the nursery tank, and disposing the standing mesh drain pipe comprising a 40-80 mesh screen in the center of the nursery tank, the standing mesh drain pipe communicating with the second drain window;

1.3) disposing the first aerotube around the bottom of the inner wall of the nursery tank;

1.4) disposing a first water pipe and a second water pipe at two opposite corners of the nursery tank and above the water level thereof, respectively, connecting the first water pipe to a first outlet of the first water treatment system and connecting the first water pipe to a second outlet of the second water treatment system, such that the two-way water treatment system continuously supplies high-quality clean water for the nursery tank.

In a class of this embodiment, building the dual-drain recirculating water treatment system comprises:

2.1) disposing a first water treatment system;

2.2) disposing a second water treatment system.

In a class of this embodiment, disposing a first water treatment system comprises the following steps:

2.1.1) disposing a first filter net cage to communicate with an inlet of the first filtering basin to filter the upper layer water from the nursery tank; precipitating the solid wastes of the upper layer water at the bottom of the first filter net cage, and allowing the clean water to enter the first biological filtering basin;

2.1.2) disposing a second aerotube at the bottom around the wall of the first biological filtering basin, and disposing a plurality of first biological filtration brushes vertically up and down in the first biological filtering basin;

2.1.3) disposing a first airlift pump in the first water reservoir; storing the upper layer water filtered through the first biological filtering basin in the first water reservoir and pumping into the nursery tank by the first airlift pump, to provide high-quality purified water for fish larvae; wherein, the first airlift pump is a nano-tubular airlift pump comprising a first PVC tube with an inner diameter of 60 to 100 mm and a fourth aerotube with a length of 200 to 800 mm disposed inside the first PVC tube; one end of the fourth aerotube is blocked and the other end is connected to an air tube equipped with a valve and connected to a blower;

2.1.4) inflating the fourth aerotube to produce microbubbles, allowing the microbubbles to flow along with the upper layer water out of the first PVC tube and enter the nursery tank.

In a class of this embodiment, disposing the second water treatment system comprises the following steps:

2.2.1) disposing a second filter net cage to communicate with an inlet of the second filtering basin to filter the lower layer water from the nursery tank; precipitating the solid wastes of the lower layer water at the bottom of the second filter net cage, and allowing the clean water to enter the second biological filtering basin;

2.2.2) disposing a third aerotube at the bottom around the wall of the second biological filtering basin, and disposing a plurality of second biological filtration brushes vertically up and down in the second biological filtering basin;

2.2.3) disposing a second airlift pump in the second water reservoir; storing the lower layer water filtered through the second biological filtering basin in the second water reservoir and pumping into the nursery tank by the second airlift pump, to provide high-quality purified water for fish larvae; and

2.2.4) inflating the second airlift pump to produce microbubbles, allowing the microbubbles to flow along with the lower layer water and enter the nursery tank.

Compared with conventional indoor culture of larvae, the following advantages are associated with the device for high density culture of fish larvae of the disclosure:

1) The nursery tank is particularly suitable for the growth and development of fish larvae. The nano-microbubble flow steam curtain formed by the first aerotube provides a barrier protection for the nursery tank, to prevent fish larvae from being frightened and hitting the wall to cause injured or death. Conventionally, the jaw malformation caused by the walling behavior in the intensive culture of larvae was generally 18-64%, and the microbubble curtain could prevent walling behavior, thereby reducing the resulting jaw malformation (less than 0.23%) effectively. The closed-loop vertical slow flow and horizontal slow flow of the airlift pump provide a warm and oxygen-rich micro-ecological environment for the fish larvae. The dissolved oxygen content can be maintained above 7 mg/L, promoting the growth of probiotics; the rounded corner design or the design without dead corners avoids the anaerobic environment and eliminates the anaerobic environment that is beneficial to the growth of pathogenic bacteria, which is also conducive to the disease prevention and treatment of fish larvae.

2) In view of the characteristics of high water quality requirement and strong stability requirement, the water treatment system on two sides of the nursery tank adopts simple, fast and reliable water purification methods, namely, mesh fabric filtration and biological filtration brush methods. The water treatment system has the advantages of fast probiotics biofilm development, high purification efficiency, stable performance, easy and thorough cleaning, and small interference to fish larvae, etc. The device and method involve no complex equipment, no equipment overhaul, thereby reducing the construction and operating costs.

3) The maturity of the biological flora of the biological purification system has a good synchronization and coordination with the water quality of the nursery tank in this disclosure. As shown in FIG. 5, the shad larvae are cultured in high density in this disclosure. During the early stage of the culture of the larvae, the water pollution is low and the content of the ammonia nitrogen and nitrite is low (ammonia nitrogen <0.08; nitrite <0.02). At this time, the circulation of the nursery tank and the purification system is mainly to maintain the stability of the nursery system. In the middle stage of the culture of larvae (from Day 20), especially after feeding the starter feed, the content of ammonia nitrogen and nitrite begins to gradually increase, and the flora of the biological purification system become gradually mature. At this time, by speeding up the water circulation, the water exchange volume is increased, and the solid wastes collected in the screen filtration cage and the biological filter brush are cleaned, 10-30% of the well water is supplemented, to control the ammonia nitrogen and nitrite to a low level (ammonia nitrogen <0.45; nitrite <0.08). The shad larvae grow well, and the survival rate and growth rate are satisfactory. The results show that the water treatment system works well and can effectively purify water. It should be noted that, in the nursery tank with probiotics (Jianyuan EM bacterial liquid, produced by Suzhou Jianyuan Biotechnology Co., Ltd.) added to the water treatment filtering medium, the content of ammonia nitrogen and nitrite can be controlled at a lower level (ammonia nitrogen <0.26; nitrite <0.03, as shown in FIG. 5). Therefore, the addition of probiotics can promote the rapid growth of beneficial microbial colonies, which plays an important role in maintaining a good micro-ecological environment.

In this disclosure, the nursery tank provides a warm and excellent imitative ecological environment for larvae. The water treatment system ensures excellent and stable water quality and provides effective nursery facilities and methods for culture of rare fish larvae. Taking shad as an example, for conventional indoor larvae culturing method, the larvae density is 1,900/m², after 50 days of culturing, the larvae will be 30 to 50 mm and the survival rate will be 11.01% to 15.72%. Using the technology of this disclosure, the larvae density is 3000/m², and the larvae survival rate reaches 43-61 mm after 40 days of cultivation and the larvae survival rate is 55.6%. The shad larvae cultured in this disclosure have the characteristics of high stocking density, fast growth, high survival rate, and very low deformity rate, which fully demonstrate the advantages of larvae culture efficiency and can be used for the culture of other fish larvae, with great promotion value.

### BRIEF DESCRIPTION OF THE DRAWINGS

FIG. 1 is a top view of a nursery tank equipped with a dual-drain recirculating water treatment system according to one embodiment of the disclosure;

FIG. 2 is a flow chart of a nursery tank equipped with a dual-drain recirculating water treatment system according to one embodiment of the disclosure;

FIG. 3 is a schematic view of a nano-tubular airlift pump according to one embodiment of the disclosure;

FIG. 4 is an oxygen supplementation efficiency curve of a nano-tubular airlift pump according to one embodiment of the disclosure;

FIG. 5 is a change curve of the ammonia nitrogen and nitrite content during the shad larvae culturing period;

FIG. 6 shows the culturing and feeding of shads;

FIG. 7 is a front view of a first biological filtering basin according to one embodiment of the disclosure; and

FIG. 8 is a top view of a second biological filtering basin according to one embodiment of the disclosure.

In the drawings, the following reference numbers are used: 1. Nursery tank; 2. First aerotube; 3. Standing mesh drain pipe; 4. Second drain window; 5. First drain window; 6. Second water outlet; 7. First water outlet; 8. First water treatment system; 9. Second water treatment system; 10. First filtering basin; 11. First biological filtering basin; 12. First airlift pump; 13. First water reservoir; 14. Second filtering basin; 15. Second biological filtering basin; 16. Second airlift pump; 17. Second water reservoir; 18a. First filter net cage; 18b. Second filter net cage; 19. Discharge port; 20a. Second aerotube; 20b. Third aerotube; 21a. First biological filtration brush; 21b. Second biological filtration brush; 22. First PVC tube; 23. Fourth aerotube; and 24. Valve.

### DETAILED DESCRIPTION

To further illustrate, embodiments detailing a device for cultivating fish larvae with high density and a method for constructing the same are described below. It should be noted that the following embodiments are intended to describe and not to limit the disclosure.

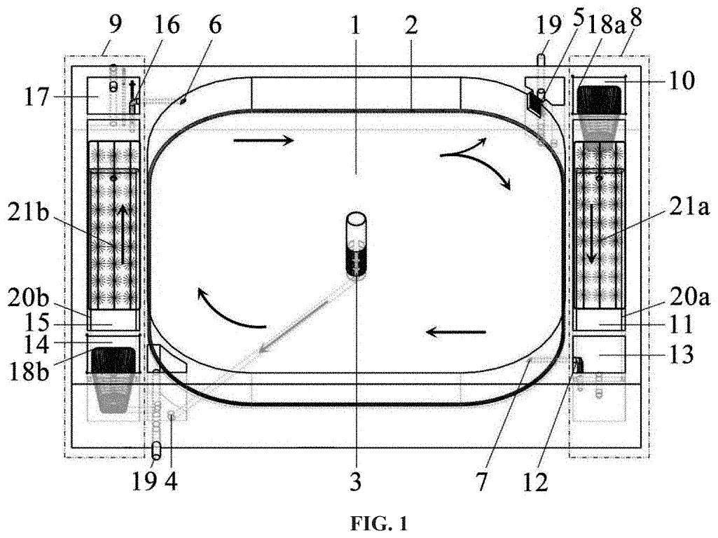

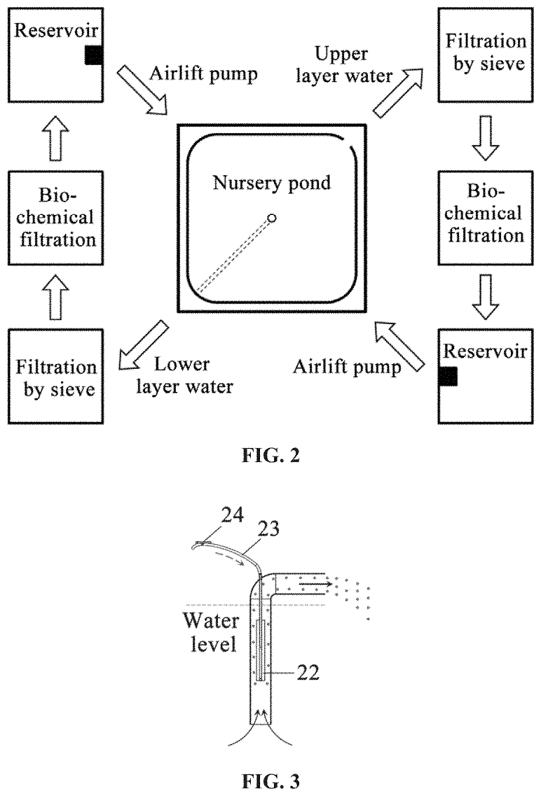

Referring to FIG. 1 and FIG. 2, the disclosure provides an device for high-density culture of fish larvae comprising a nursery tank 1, a first aerotube 2, a standing mesh drain pipe 3, and a dual-drain recirculating water treatment system; the nursery tank 1 is a rounded corner tank or a polygonal tank without dead corners; the first aerotube 2 is disposed around the bottom of the inner wall of the nursery tank 1; the standing mesh drain pipe 3 is disposed in the center of the bottom of the nursery tank 1; the dual-drain recirculating water treatment system comprises a first water treatment system 8 and a second water treatment system 9; the upper layer water in the nursery tank 1 is in communication with the interior of the nursery tank 1 through the standing mesh drain pipe 3 and the second water treatment system 9; the first water treatment system 8 and the second water treatment system 9 are symmetrically disposed on both sides of the nursery tank 1. Wherein, the arrows in FIG. 1 indicate the directions of water flow. The upper layer water in the nursery tank 1 is in communication with the interior of the nursery tank 1 through the first water treatment system 8, which means that the upper layer water in the nursery tank 1 forms a cycle between nursery tank 1 and first water treatment system 8, that is, the contaminated upper layer water in the nursery tank 1 flows into the first water treatment system 8 and then flows back into the interior of the nursery tank 1 after purification. The lower layer water in the nursery tank 1 is in communication with the interior of the nursery tank 1 through the standing mesh drain pipe 3 and second water treatment system 9, which means that the lower layer water in nursery tank 1 forms a cycle between the nursery tank 1, the standing mesh drain pipe 3 and the second water treatment system 9, that is, the contaminated lower layer water in the nursery tank 1 flows into the second water treatment system 9 through the standing mesh drain pipe 3, and then flows back into the interior of the nursery tank 1 after purification.

The first water treatment system 8 comprises a first drain window 5 disposed on the wall of the nursery tank, a first filter net cage 18a, a first filtering basin 10, a first biological filtering basin 11, a first water reservoir 13, a first airlift pump 12 and a first water outlet 7; the upper layer water in the nursery tank 1 passes through the first drain window 5 on the tank wall, the first filter net cage 18a, the first filtering basin 10 and the first biological filtering basin 11 successively, and is stored in the first water reservoir 13; the first airlift pump 12 is disposed in the first water reservoir 13; the first water reservoir 13 communicates with the nursery tank 1 through the first airlift pump 12 and the first water outlet 7. The second water treatment system 9 comprises a second drain window 4, a second filter net cage 18b, a second filtering basin 14, a second biological filtering basin 15, a second water reservoir 17, a second airlift pump 16 and a second water outlet 6; the lower layer water in the nursery tank 1 passes through the standing mesh drain pipe 3, the second drain window 4, the second filter net cage 18b, the second filtering basin 14, and the second biological filtering basin 15 successively, and is stored in the second water reservoir 17; the second airlift pump 16 is disposed in the second water reservoir 17; the second water reservoir 17 communicates with the bottom of the nursery tank 1 through the second airlift pump 16 and the second water outlet 6.

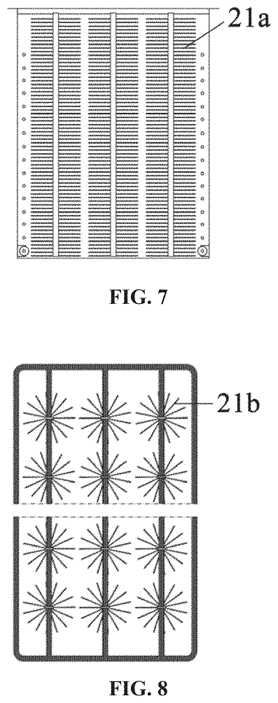

Referring to FIG. 7 and FIG. 8, the first biological filtering basin 11 of the disclosure comprises a second aerotube 20a disposed along the flow direction of water and a second biological filtration brush 21a connected to the second aerotube 20a; the second biological filtering basin 15 comprises a third aerotube 20b disposed along the flow direction of water and a second biological filtration brush 21b connected to the third aerotube 20b. Wherein, the structure of the second aerotube 20a is the same as that of the third aerotube 20b, and the structure of first biological filtration brush 21a is the same as that of the second biological filtration brush 21b. In actual applications, the structure of first biological filtering basin 11 is the same as that of the second biological filtering basin 15. In addition, the first filter net cage 18a and second filter net cage 18b water are both screens of 50 to 80 meshes. It can be understood that, in other embodiments, one of the first filter net cage 18a and the second filter net cage 18b may be a screen of 50 to 80 meshes.

Referring to FIG. 3, the second airlift pump of the disclosure is a nano-tubular airlift pump disposed below the liquid level of the second water reservoir 17. The nano-tubular airlift pump comprises a first PVC tube 22 (polyvinyl chloride tube also known as PVC tube) and a fourth aerotube 23 disposed inside the first PVC tube 22; the length of the fourth aerotube 23 is in the range of 200 to 800 mm; the inner diameter of the first PVC tube 22 is in the range of 60 to 100 mm. One end of the fourth aerotube 23 is blocked, and the other end of the fourth aerotube 23 is connected to a valve 24. The first PVC tube 22 and fourth aerotube 23 are both disposed below the liquid level of the second water reservoir 17. It can be understood that in other embodiments, the first airlift pump 12 is a nano-tubular airlift pump disposed below the liquid level of the first water reservoir 13, and the structure of the first airlift pump 12 is the same as that of the second airlift pump 16 in this embodiment, which is not described herein.

The first aerotube 2, the second aerotube 20a, the third aerotube 20b, and fourth aerotube 23 are all nano aerotubes that can provide aeration function and can be used to increase oxygen and remove CO₂ in water, thereby improving the water quality.

The standing mesh drain pipe 3 comprises a second PVC tube (not shown) and a central filter screen (not shown) covering the nozzle of the second PVC tube. The central filter screen comprises a screen of 40 to 80 meshes. The device for high-density culture of fish larvae further comprises a discharge port 19 communicating with the nursery tank 1.

The nursery tank 1 has an area of 10 to 50 m², and contains water in a depth of 0.8 to 1.5 m. The shads are not suitable to be moved and are easy to be frightened. If the nursery tank is too small, shads may flee or jump frantically that will cause collisions or hit the walls to death once the sound and light change suddenly.

The construction method of the device provided by this disclosure comprises the following steps: 1. building the nursery tank, the nursery tank comprising a nano-microbubble flow steam curtain and configured for suspension growth of fish larvae and probiotics; 2. building a dual-drain recirculating water treatment system comprising a mesh fabric filtration and biological nitrification purification tank and a tubular microbubble airlift pump for the production of nano-aeration tubes; 3. connecting the nursery tank to the water treatment system to form a whole structure through the airlift pump, thereby forming the device for high density culture of fish larvae comprising the dual-drain recirculating water treatment system and the airlift pump. Specifically, the method comprises:

1. building the nursery tank, the nursery tank comprising a nano-microbubble flow steam curtain and configured for suspension growth of fish larvae and probiotics:

1.1) The shape of the nursery tank: The nursery tank is a rounded corner tank or a polygonal tank with four corners cut off (no right angles). Since the shads have a fast swimming behavior around the clock in a straight line instead of turning, the shad larvae will always swim against the dead corners when encountering a right angle, which is likely to cause head injury or death.

1.2) The area of the nursery tank is 10 to 50 square meters, and the water depth is 0.8 to 1.5 meters. Shads are not suitable to be moved and are easy to be frightened. If the nursery tank is too small, shads may flee or jump frantically that will cause collisions or hit the walls to death once the sound and light change suddenly.

1.3) The center at the bottom of the nursery tank is provided with the second drain window, and the standing mesh drain pipe is disposed vertically in the second drain window. The standing mesh drain pipe comprises a second PVC tube comprising a plurality of holes and a central filter screen covering the opening of the second PVC tube. The central filter screen is in the range of 40 to 80 meshes. The aquaculture water is filtered and flows to the water outlet, but the fish larvae are blocked by the screen, to prevent larvae from escaping.

1.4) The first aerotube is disposed around the bottom of the inner wall of the nursery tank. When the first aerotube is inflated, a nano-microbubble flow steam curtain mixed with aerosol water is formed around the wall of the tank, which provides barrier protection for the nursery tank while increasing oxygen and forming a slow flow, thus preventing the fish larvae from hitting the tank wall or death under emergency; and more importantly, the strength of the nano-microbubble flow steam curtain is adjustable during the medium term of culture, thus preventing the fish larvae from approaching the wall, effectively preventing the walling behaviors in the medium term of culture, reducing the rate of jaw malformation or preventing the walling behavior in the medium term of culture, and avoiding the resulting jaw malformation.

1.5) A first water pipe and a second water pipe are disposed at two opposite corners of the nursery tank and above the water level of the nursery tank, respectively, functioning as the outlet pipes of the first airlift pump and the second airlift pump to continuously provide high-quality clean water for nursery tanks. Specifically, the first water pipe communicates with the first airlift pump to form a part of the first water treatment system; and the second water pipe communicates with the second airlift pump to form a part of the second water treatment system.

1.6) Formation of omnidirectional dynamic slow flow: the slow flow of the nursery tank comprises two parts of dynamic mixing, namely, the closed-loop vertical slow flow and the airlift pump horizontal slow flow. Firstly, the slow flow direction of the nano-microbubble flow steam curtain around the tank wall is upward from the bottom of the tank wall, and from the outside to the inside on the water surface, and then downward in the central area to the tank wall from the inside to the outside, forming a closed-loop vertical slow flow; the horizontal slow flow is formed by the micro-bubble water flow of the diagonal airlift pump. The closed-loop vertical slow flow and airlift pump horizontal slow flow form a complex omnidirectional three-dimensional slow flow, forming a uniform, oxygen-enriched environment without dead corners, which is suitable for the floating behavior of newly hatched larvae and probiotics, and also suitable for habit of flowing against the water of the fish larvae in the middle and late stage. Thus, a healthy micro-ecological environment for fish larvae is constituted.

2. Building a dual-drain recirculating water treatment system, comprising a screen filtration and a biological nitrification purification tank.

2.1) The basic structure of the dual-drain recirculating water treatment system: the two water treatment systems with the same structure located on two sides of the nursery tank are used to treat the upper layer water and lower layer water of the nursery tank, respectively. The first water treatment system comprises a first filtering basin, a first biological nitrification purification tank, and a first water reservoir provided with the first airlift pump. The second water treatment system comprises a second filtering basin, a second biological nitrification purification tank, and a second water reservoir provided with the second airlift pump.

2.2) First filtering basin: A first water filter tank provided with a first filter net cage (screen of 50 to 80 meshes) is used to filter the upper layer water in the nursery tank. The collected solid waste precipitates at the bottom of the first filter net cage, and the filtered clean water flows into the first biological filtering basin.

Second filtering basin: A second water filter tank provided with a second filter net cage (screen of 50 to 80 meshes) is used to filter the lower layer water in the nursery tank. The collected solid waste precipitates at the bottom of the second filter net cage, and the filtered clean water flows into the second biological filtering basin.

2.3) First biological filtering basin: A second aerotube is disposed at the bottom of the wall of the nursery tank, to provide aeration functions for biological water purification, that is, oxygen supplementation and removal of CO₂. The first biological filtering basin is provided with the first biological filtration brush disposed vertically up and down. The filter material is easy to clean and has the function of quickly culturing probiotics and intercepting and adsorbing particulate matters. The biofilm can be formed quickly and remains stable, which is suitable for the short-term and quick-acting production of larvae.

Second biological filtering basin: A third aerotube is disposed at the bottom of the wall of the nursery tank, to provide aeration functions for biological water purification, that is, oxygen supplementation and removal of CO₂. The second biological filtering basin is provided with the second biological filtration brush disposed vertically up and down. The filter material is easy to clean and has the function of quickly culturing probiotics and intercepting and adsorbing particulate matters. The biofilm can be formed quickly and remains stable, which is suitable for the short-term and quick-acting production of larvae.

2.4) First water reservoir: A first airlift pump is disposed inside the first water reservoir. The water filtered by the first biological filtering basin is reserved in the first water reservoir and pumped into the nursery tank by the first airlift pump, to provide high-quality purified water for fish larvae.

Second water reservoir: A second airlift pump is disposed inside the second water reservoir. The water filtered by the second biological filtering basin is reserved in the second water reservoir and pumped into the nursery tank by the second airlift pump, to provide high-quality purified water for fish larvae.

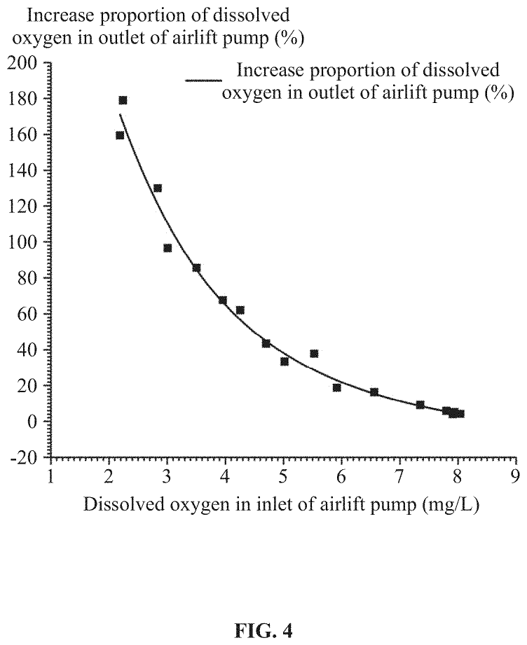

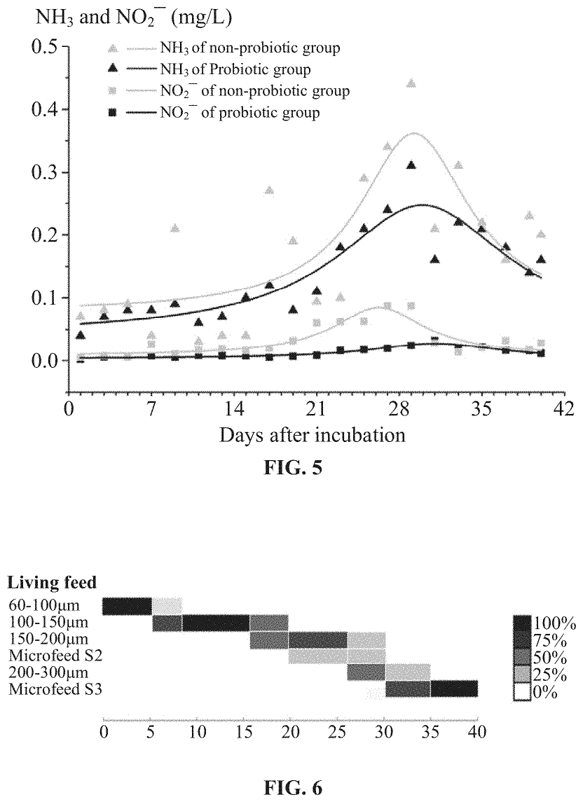

2.5) First airlift pump and second airlift pump: The first airlift pump and the second airlift pump are both nano-tubular airlift pumps. Preparation of the nano-tubular airlift pump (that is, micro-bubble airlift pump of nano aerotube): As shown in FIG. 3, the nano-tubular airlift pump comprises a first PVC tube with an inner diameter of 60 to 100 mm and a fourth aerotube with a length of 200 to 800 mm disposed inside the first PVC tube. One end of the fourth aerotube is blocked and the other end of the fourth aerotube is connected to an air tube that is provided with a valve. When the fourth aerotube is inflated, the formed water flow of floating microbubbles flows out of the upper port of the first PVC tube and flows into the nursery tank; the microbubbles formed by fourth aerotube are very small (<0.2 mm in diameter, while the air bubbles aerated by airstone has a diameter of 1.4 to 3.6 mm), and the water flow formed is microbubble water flow, which is very gentle and will not harm fish larvae. The existing airlift pump adopts the airstone aeration. The bubbles are large and the flow velocity is high. When the bubbles hit fish larvae, fish bodies are often knocked over, or yolk sacs are detached, causing death finally. The nano-tubular airlift pump of the disclosure has a significant effect on oxygen supplementation. As shown from FIG. 4, when the temperature is 20-22° C., the average oxygen supplementation efficiency is more than 90%. The oxygen supplementation efficiency increases with the decrease of the dissolved oxygen content of the water inlet. When the dissolved oxygen content of the water inlet is 2 mg/L, the oxygen supplementation efficiency is 180%. Another advantage of the nano-tubular airlift pump is that the water flow in the airlift pump can be adjusted by the air pressure of the air valve, which is convenient and easy to operate. The nursery tank and the water treatment system are circulated into a whole through the nano-tubular airlift pump, to form a “dual-drain recirculating water biological purification and culture system of fish larvae with airlift pump”. The purified water of the water treatment system is pumped into the nursery tank through the nano-tubular airlift pump, thereby driving the water in the nursery tank to flow into the water treatment system through the second drain window and the first drain window respectively for purification. The circulating water flow of the airlift pump is adjustable and controllable. During the early stage of the culture of larvae, the fish larvae have poor exercise ability. An airlift pump micro-flow water circulation can be used to help them float in the nursery tank. As the fish larvae continue to grow, the swarming ability of fish larvae increases and the food intake increases. By increasing the amount of micro-flow water circulation, the water purification exchange rate is increased, to improve and maintain a good water quality.

In view of the fact that the newly hatched larvae are fine and delicate and are in the sensitive and critical period of their growth and metamorphosis, according to their characteristics of extreme sensitivity to changes in the external environment and water quality and their unique biological habits, a dual-drain recirculating water biological purification and culture system of fish larvae with airlift pumps is designed and built through the integration of modern engineering technology and micro-ecological technology, for the purpose of risk controls such as avoiding mechanical damage, disease prevention and control, and reducing the physiological stress response caused by environmental degradation. An imitative ecological oxygen-enriched environment (nursery tank) that is suitable for the growth of fish larvae and probiotics, and a mesh fabric filtration and biological nitrification water treatment system (including lower layer water and upper layer water treatment system) is provided to purify the water quality, remove hazardous substances such as solid wastes, ammonia nitrogen and sub-salts, and integrate the functions of the nursery tank (with nano-microbubble flow steam curtain)-dual-cycle oxygen-enriched water biological purification-microbubble airlift pump cycle (oxygen supplementation) as a whole, to establish a full-scale oxygen-rich imitative ecological dual-drain recirculating water culture system.

In this disclosure, by focusing on the risk control measures such as avoiding mechanical damage, disease prevention and control, and reducing the physiological stress response caused by environmental degradation and integrating the following measures, a stable microecological environment suitable for the growth of fish larvae and probiotics is established, to reduce the damage to fish larvae caused by water flow, prevent walling behavior, increase the growth rate and survival rate, and reduce the malformation rate. Firstly, through the dual-drain recirculating water treatment system, the hazardous substances such as solid wastes, ammonia nitrogen and nitrite, are removed, and the water quality is purified, to avoid the deterioration of water quality and the resulting physiological stress response to poison fish larvae; by adjusting the air pressure of the nano aerotube (Aeration Tube™), the oxygen supplementation efficiency is improved, providing an oxygen-rich culture environment for fish larvae, and the aerosol water fusion generated on the surrounding tank wall forms an adjustable nano-microbubble flow steam curtain to prevent or slow down fish larvae from hitting the tank wall in an emergency. More importantly, by adjusting the strength of the flow steam curtain during the medium term of culture, the fish larvae cannot approach the wall, hereby effectively preventing the common walling behaviors in the medium term of culture, reducing the rate of jaw malformation. The nano-tubular airlift pump forms aerosol water mixed with microbubble water flow to circulate the nursery tank and the water treatment system, which not only improves the oxygen supplementation efficiency, but also avoids the impact of the traditional water pump to damage fish larvae, and reduce the malformation rate; finally, the nursery tank formed by the micro-bubble flow curtain and the airlift pump micro-bubble water flow forms a slow flow in all directions without dead corners, which satisfies the floating behavior of the newly hatched larvae and probiotics and the oxygen-rich nursery tank micro-ecological environment, inhibits the growth of pathogenic bacteria that like anaerobic environment, prevents diseases and improves the survival rate.

The device of the disclosure has at least the following six design characteristics:

1. A nano aerotube (Aeration Tube™) is disposed along the inner wall of the nursery tank for micro-bubble aeration to improve oxygen supplementation efficiency;

2. An adjustable “nano-microbubble flow steam curtain” is formed by controlling the aeration of the nano aerotube, and a three-dimensional slow flow of water is formed in the nursery tank, without dead corners (eliminating the anaerobic environment favored by pathogenic bacteria). It is suitable for the growth of newly hatched larvae and planktonic probiotics, providing a warm and healthy environment for the fish larvae; the adjustable nano-microbubble flow steam curtain can prevent or slow down the fish larvae from colliding with the tank wall in an emergency, and more importantly, the strength of the flow steam curtain can be adjusted during the medium term of culture, to prevent the fish larvae from approaching the wall, thereby effectively preventing the common walling behaviors in the medium term of culture, reducing the rate of jaw malformation;

3. In this disclosure, the nano-tubular airlift pump can not only achieve oxygen supplementation effectively, but also become a driving force of circulation, to form a slow flow in the nursery tank, avoiding damage to the fish larvae by the water pump and the ordinary tubular airlift pump in the conventional method. The ordinary tubular airlift pump utilizes the airstone aeration with large bubbles. The oxygen supplementation efficiency is not high and the formed water stream contains large bubbles. The bubbles hit the fish larvae to cause damage to them, especially more serious to fish larvae in the early stage;

4. The water purification of the nursery system is completed by two sets of water treatment systems with different properties on two sides of the nursery tank, with stable and reliable purification performance. The sewage of the nursery tank is purified by the water treatment systems on two sides of the nursery tank through two-way discharge, namely, the lower layer water and the upper layer water. As shown in FIG. 2, the lower layer water and upper layer water in their respective water treatment systems are filtered through the mesh fabric filtration cage successively. The filtered clean water enters the oxygen-enriched biological filter tank, and then enters the reservoir after water purification, and then flows into the nursery tank by an airlift pump. The lower layer water is characterized by turbid water and more solid wastes. Its water treatment system focuses on cleaning. The dense mesh fabric filtration can be utilized, and the biological filter has a small aeration volume, which is convenient for the filter materials to intercept and adsorb particulates. The upper layer water is characterized by clear water, which can be filtered by a thicker sieve silkscreen. The water treatment system focuses on biological purification, which is especially important in the later stage of culture. Therefore, the aeration volume of the biological filter should be large to improve the biological purification efficiency.

5. The biological purification filter materials facilitate the implantation of probiotics. The biofilm can be formed within a week, and can intercept the biological filter brushes that adsorb particulates (the filter brushes and biological filter brushes emphasize the biological water treatment functions. The Yeben mountain tree brush is used in this disclosure), which is easy to clean and very suitable for the short-term and quick-acting larvae culturing. The commonly used filter materials for industrial aquaculture are filter beads or filter balls, although the filter balls have a relatively large surface, the microbial colony has a long maturity period (usually more than one month) and it is difficult to clean, which is suitable for breeding of long-period adult fish and is not suitable for the larvae production.

6. The dual-drain recirculating water treatment system on two sides of the nursery tank can be adjusted according to the water quality requirements of each stage of larvae culture, that is, the contaminated water from the nursery tank upper layer water and lower layer water is purified and the volume of recycled water is adjusted respectively. During the early stage of larvae culture, more than 80% of nursery water is the water purified through the second water treatment system, mainly because the organic load of nursery tank is low at this time, and there is no need for large exchange volume. In addition, the fish larvae are weaker, the water outlet area of the central pipe strainer at the second drain window is large and the suction is small. So it is not suitable to suck the fish larvae into the sieve silkscreen, causing injury to the fish larvae sticking to the cage. Therefore, in the early stage of larvae culture, it is mainly based on the second water treatment system and supplemented by the surface layer water treatment system. However, 20% of the nursery water recycles to cultivate the biological flora. With the growth of the fish larvae, the organic load of nursery tanks continues to increase, to increase the recycling volume of upper layer water purification continuously. The internal recycling of the system ensures the stability of water quality and reduces the harms of organic loads and water contamination.

In summary, the dual-drain recirculating water treatment system not only removes solid waste, ammonia nitrogen and nitrite and other harmful substances and reduces stress response, but also improves the controllability and purification efficiency of various water chemical indicators in the nursery water. According to the above analysis, the dual-drain recirculating water biological purification and culture system of fish larvae with airlift pump is a plane-integrated low-lift energy-saving system. There is no need of complex and expensive equipment. It has the advantages of simple structure, convenient operation, high purification efficiency, strong controllability, stable performance, low construction and operating costs, and no interference with the fish larvae, providing a healthy, ecological, sustainable, and risk-controllable high-density nursery system for high-density larvae culture. Years of experiences in larvae culture of rare fish such as shads have proven that the system can not only effectively increase the growth rate and survival rate, but also produce fish larvae of uniform size, with low malformation rate, strong physique, strong resistance to stress. Therefore, it has a strong promotion potential.

The technical solutions provided by this disclosure will be described in detail below in conjunction with the drawings.

High-density culture of shad larvae

Shad larvae are very delicate and have different swimming behaviors and physiological requirements at different developmental stages; in addition, they are very sensitive to the external environment and water quality. During the larvae culture period, it is required to provide a warm environment and adjust the management method of aeration volume according to different swimming behaviors, to prevent the self-harming against the wall and reduce the malformation rate. The shad high-density nursery system comprises a nursery tank and water treatment systems on both sides, as shown in FIG. 1 and FIG. 2.

1. Construction of nursery tank:

1.1) Nursery tank 1 is a rounded corner tank or a polygonal tank without dead corners, with a specification of 10 to 50 square meters and a water depth of 0.8 to 1.5 meters. The existing nursery tanks are mostly rectangular or square with dead spaces. Shads have the behavior of fast swimming day and night and they can swim in a straight line and cannot turn to swim. When encountering a right angle, shad larvae will always swim against the dead spaces, which is likely to cause head injury or death.

1.2) A first aerotube is disposed at the bottom around the walls of the nursery tank. When the nano aerotube is inflated, an aerosol-water mixed microbubble curtain is formed around the tank wall, which has the functions of oxygen supplementation and preventing larvae from colliding with the tank wall to be injured or killed. At present, the conventional aeration method for larvae culture is to distribute several airstones in the nursery tank for oxygen supplementation. The method has two drawbacks: First, because the air bubbles of airstone aeration are large, the momentum near the airstone is relatively large, and a swirling flow will be formed between the airstones. The uneven aeration will cause direct harm to fish larvae. The newly hatched larvae are in the floating stage and they are extremely delicate, small in size, and large in yolk sacs. The high aeration impulse can easily cause the yolk sac to rupture and the fish larvae to die. As reported by Yan Yinlong et al. in 2020, the first death peak of shad larvae culture is 1 to 4 days after hatching, which is in the fish larvae' floating period. The air bubbles of airstone aeration are large, with greater momentum and swirling, which is easy to strike the yolk sac, causing the yolk sac to rupture or die after separation from the fish body. Second, because of uneven aeration of airstones, the bottom or corners around the nursery tank will inevitably become anaerobic zone, which are easy to accumulate feces and other solid wastes. Especially in the early stage of larvae culture, the fish larvae have poor swimming ability and cannot absorb contaminant; moreover, water change in a large amount cannot be achieved, so the anaerobic zone is an area where pathogenic bacteria can easily breed. As reported by Yan Yinlong et al. in 2020, the second peak of death of shad larvae is on the 8^{th} to 12^{th} day after hatching. The reason for “death of larvae” is related to the poor water quality management in the early stage, weak physical condition, and uneven aeration method.

1.3) The center at the bottom of the nursery tank is provided with the second drain window 4. In the second drain window, a standing mesh drain pipe 3 comprising a second PVC tube and a central filter screen covering the opening of the second PVC tube is disposed vertically, to extend the water outlet surface area. The second PVC tube comprises a plurality of holes, and the central filter screen is in the range of 40 to 80 meshes. The aquaculture water flows into the second drain window 4 after filtering, but the fish larvae are separated by the screen to prevent fish larvae from escaping from the second drain window 4 or prevent fish larvae from sticking to the screen.

1.4) The first drain window 5 on the tank wall is located on the nursery tank wall adjacent to the first filtering basin 10 of the first water treatment system 8.

1.5) A first water pipe and a second water pipe are disposed at two opposite corners of the nursery tank and above the water level of the nursery tank, respectively, functioning as the outlet pipes of the first airlift pump and the second airlift pump to continuously provide high-quality clean water for nursery tanks.

2. Building a two-way water treatment system, comprising a screen filtration and a biological nitrification purification tank.

2.1) The two-way water treatment system is two water treatment systems with the same structure located on two sides of the nursery tank, namely, the first water treatment system 8 and the second water treatment system 9. The first water treatment system 8 comprises a first filtering basin 10, a first biological filtering basin 11, and a first water reservoir 13 provided with a first airlift pump 12; the second water treatment system 9 comprises a second filtering basin 14, a second biological filtering basin 15, and a second water reservoir 17 provided with second airlift pump 16.

2.2) First filtering basin 10 and second filtering basin 14: The filtering basin provided with the first filter net cage 18a with screen of 50 to 80 meshes and the second filter net cage 18b with screen of 50 to 80 meshes are used to filter the upper layer water and the lower layer water in the nursery tank. The collected solid wastes settle at the bottom of the cage, and the filtered clean water flows into the first biological filtering basin 11 and second biological filtering basin 15.

2.3) First biological filtering basin 11 and second biological filtering basin 15: The second aerotube 20a and the third aerotube 20b are respectively disposed at the bottom of the tank wall to provide aeration functions for the biological water purification, namely, oxygen supplementation and removal of CO₂. The first biological filtering basin is provided with first biological filtration brushes 21a that are easy to clean, and the second biological filtering basin is provided with second biological filtration brushes 21b. The first biological filtration brushes 21a and the second biological filtration brushes 21b have the functions of quickly culturing probiotics, and intercept and adsorb particulate matters. The biofilm is formed quickly and is stable and sustainable, which is suitable for short-term and quick-acting larvae production.

2.4) First water reservoir 13 and second water reservoir 17: The first airlift pump 12 and the second airlift pump 16 are disposed inside respectively. The water filtered through the first biological filtering basin is stored in the first water reservoir, and pumped into the nursery tank 1 by the first airlift pump 12, to provide high-quality clean water for the fish larvae. The water filtered through the second biological filtering basin is stored in the second water reservoir, and pumped into the nursery tank 1 by the second airlift pump 16, to provide high-quality clean water for the fish larvae.

3. The tubular first airlift pump 12 and the tubular second airlift pump 16 are disposed, and the cycle of the nursery tank 1 and first water treatment system 8 and second water treatment system 9 on both sides is started: The first airlift pump 12 and second airlift pump 16 are disposed on the first water reservoir 13 and the second filtering basin 14 diagonally opposite to the nursery tank, respectively, and are connected to the first water outlet 7 and the second water outlet 6. The nursery tank comprises two water outlets (second drain window 4 and first drain window 5 which are disposed on the tank wall), which are respectively connected to the second water treatment system 9 and first water treatment system 8. The second drain window 4 at the bottom of the nursery tank is connected to the second water treatment system 9, while the first drain window 5 on the tank wall is connected to the first water treatment system 8. When the air valve is switched on for air supply, the microbubbles generated by the first airlift pump 12 and the second airlift pump 16 flow out of the second water outlet 6 and the first water outlet 7, and enter the nursery tank 1 respectively to form a horizontal slow flow, which blends with the closed-loop vertical slow flow to constitute a complex omnidirectional three-dimensional slow flow. In this way, a uniform, oxygen-enriched environment without dead corners is formed, which is suitable for the floating behavior of newly hatched larvae and probiotics, and also suitable for habit of flowing against the water of the fish larvae in the middle stage. Thus, a healthy micro-ecological environment for larvae is constituted.

4. Management of larvae culture:

4.1) Putting fish larvae: Before putting fish larvae into the nursery tank, the water in the nursery tank is filled up; the first airlift pump 12 and the second airlift pump 16 are switched on to circulate water through the nursery tank; the first aerotube 2 is switched on for aeration for 1 to 2 days; the water temperature during aeration is controlled at 18 to 22° C. Before putting the fish larvae into the nursery tank, the self-culturing fresh probiotics are implanted in the first and second biological filtering basins. The probiotics are easy to implant on the brush filter material, and after being activated by sufficient aeration, they enter the nursery tank. At the same time, the air volumes produced by the first airlift pump 12, the second airlift pump 16 and the first aerotube 2 are reduced, forming a slow microflow to make it suitable for newly hatched larvae to float. The newly hatched larvae are put into the nursery tank at a density of 1,000-5,000/m³.

4.2) Management of newly hatched larvae: As shown in FIG. 6, on the first day of hatching, the oocystis is added into the nursery tank, and the water color remains light green for 10 consecutive days. The water temperature is controlled at 18 to 22° C. On the 2^{nd} and 3^{rd} days after hatching, the newly hatched larvae begin to eat. They can be fed with rotifers or copepods larvae with a size of 60 to 100 um, 4 times a day, to maintain the bait density at 10-20 baits/mL. Since the 7th day after hatching, the flow rate of the first airlift pump 12 and the second airlift pump 16 is slightly added; and the rotifers or copepods larvae with a size of 60 to 100 um are fed, 4 times per day, to maintain the bait density at 10-15 baits/ml. No sewage is discharged every day, and 1% to 5% of water is added, to make up for the loss due to water evaporation.

4.3) Management in the middle stage of larvae culture: On the 15^{th} day after hatching, the fish larvae start to swim against the top water. The water flow of the first airlift pump 12 and the second airlift pump 16 is increased, but while ensuring that the fish larvae are not washed away. Every morning, the fish larvae start to swim against the tank wall, if not stopped in time, the jaw malformation may be caused for a large number of fish larvae. For this reason, the aeration volume of first aerotube 2 is increased and a larger microbubble curtain is formed around the tank wall. The air volume is appropriate to wash away the fish larvae without hitting the tank wall. At the same time, copepods and cladocerans with a size of 150 to 200 um are started to feed, 4 times a day, maintaining the bait density at 5 to 10 baits/mL. On the 20^{th} day after hatching, the starter feed (S2 microcapsule feed, Shandong Shengsuo Feed Co., Ltd.) is fed, 4 to 6 times a day, small amount each time. Every day, 5 to 10% of sewage is discharged, to clean the first filtering basin and remove the solid wastes in the filtering basin.

4.4) Management in the late stage of larvae culture: On the 25^{th} day after hatching, the fish larvae start to swim against the top water in clusters. The water flow of the first airlift pump 12 and the second airlift pump 16 is increased while ensuring that the fish larvae are not washed away. The copepods and cladocerans of 200 to 300 um are started to feed, 4 times a day, maintaining the bait density at 2 to 6 baits/mL. On the 30^{th} day after hatching, the feeding of baits is reduced gradually, and the S3 microcapsule feed (Shandong Shengsuo Feed Co., Ltd.) is fed until the fish larvae do not actively grab the feeds, 4 to 6 times a day, small amount each time. Every day, 10 to 30% of sewage is discharged, to clean the first filtering basin and the first biological filtering basin, especially to remove the solid wastes accumulated in the first filter net cage and the first biological filtration brush, to reduce the organic loading in the nursery system.

4.5) Results of larvae culture: when the shad larvae at a stocking density of 3000/m³ are cultured in the device of the disclosure for 40 days, the average weight of shad larvae is 481±26 mg, the body length is 52±14 mm, the survival rate is 55.6%, and the malformation rate is 0.27%. When the shad larvae at a stocking density of 1900/m³ are cultured in a conventional indoor rectangular tank for 50 days, the average body length of shad larvae is 45±21 mm, and the survival rate is 11.01-15.72%, and the malformation rate is greater than 23.6%. Therefore, the device of the disclosure has significant advantages in various culture index. The shad larvae not only have a high stocking density, a fast growth rate and a high survival rate, but also have a very low malformation rate, which fully demonstrates the advantage of integration and nursery efficiency of the system design combination, with a good promotional value.

It will be obvious to those skilled in the art that changes and modifications may be made, and therefore, the aim in the appended claims is to cover all such changes and modifications.

What is claimed is:

1. A device for high density culture of fish larvae, the device comprising:
a nursery tank comprising an inner wall;
a first aerotube mounted on the inner wall;
a standing mesh drain pipe; and
a dual-drain recirculating water treatment system, the dual-drain recirculating water treatment system comprising a first water treatment system and a second water treatment system;
wherein:
the nursery tank is a rounded corner tank or a polygonal tank without dead corners; the first aerotube is disposed around a bottom of the inner wall of the nursery tank; the standing mesh drain pipe is disposed in a center of a bottom of the nursery tank;
the first water treatment system and the second water treatment system are symmetrically disposed on both sides of the nursery tank, respectively;
the standing mesh drain pipe communicates with the second water treatment system; and
when in use, the first water treatment system is configured to purify upper layer water of the nursery tank, and the second water treatment system is configured to purify lower layer water of the nursery tank.

2. The device of claim 1, wherein the first water treatment system comprises a first drain window disposed at an upper part of a wall of the nursery tank, a first filter net cage, a first filtering basin, a first biological filtering basin, a first water reservoir, and a first airlift pump comprising a first water outlet; the upper layer water of the nursery tank passes through the first drain window, is purified by the first filter net cage, the first filtering basin, and the first biological filtering basin successively, and is stored in the first water reservoir; the first airlift pump is disposed in the first water reservoir; the first water reservoir communicates with the nursery tank through the first airlift pump and the first water outlet.

3. The device of claim 2, wherein the second water treatment system comprises a second drain window disposed at a lower part of the wall of the nursery tank, a second filter net cage, a second filtering basin, a second biological filtering basin, a second water reservoir, and a second airlift pump comprising a second water outlet; the lower layer water of the nursery tank passes through the standing mesh drain pipe and the second drain window, is purified by the second filter net cage, the second filtering basin, and the second biological filtering basin successively, and is stored in the second water reservoir; the second airlift pump is disposed in the second water reservoir; the second water reservoir communicates with the bottom of the nursery tank through the second airlift pump and the second water outlet.

4. The device of claim 3, wherein the first biological filtering basin comprises a second aerotube disposed along a flow direction of the upper layer water and a first biological filtration brush connected to the second aerotube; and/or the second biological filtering basin comprises a third aerotube disposed along a flow direction of the lower layer water and a second biological filtration brush connected to the third aerotube.

5. The device of claim 3, wherein the first filter net cage comprises a screen of 50 to 80 meshes; and/or the second filter net cage comprises a screen of 50 to 80 meshes.

6. The device of claim 3, wherein the first airlift pump is a first nano-tubular airlift pump disposed below a liquid level of the first water reservoir; and/or the second airlift pump is a second nano-tubular airlift pump disposed below the liquid level of the second water reservoir.

7. The device of claim 6, wherein the first/second nano-tubular airlift pump comprises a first polyvinyl chloride (PVC) tube and a fourth aerotube disposed inside the first PVC tube; one end of the fourth aerotube is blocked, and the other end of the fourth aerotube is connected to an air tube equipped with a valve and being connected to a blower.

8. The device of claim 7, wherein a length of the fourth aerotube is in the range of 200 to 800 mm; and/or an inner diameter of the first PVC tube is in the range of 60 to 100 mm.

9. The device of claim 1, wherein the standing mesh drain pipe comprises a second PVC tube and a central filter screen covering a nozzle of the second PVC tube, and the central filter screen is in the range of 40 to 80 meshes.

10. The device of claim 8, wherein the standing mesh drain pipe comprises a second PVC tube and a central filter screen covering a nozzle of the second PVC tube, and the central filter screen is in the range of 40 to 80 meshes.

11. The device of claim 1, further comprising a discharge port communicating with the nursery tank.

12. The device of claim 8, further comprising a discharge port communicating with the nursery tank.

13. The device of claim 1, wherein the nursery tank has an area of 10 to 50 m², and contains water in a depth of 0.8 to 1.5 m.

14. The device of claim 8, wherein the nursery tank has an area of 10 to 50 m², and contains water in a depth of 0.8 to 1.5 m.

15. A method for constructing the device for high-density culture of fish larvae of claim 1, the method comprising:
1) building the nursery tank, the nursery tank comprising a nano-microbubble flow steam curtain and being configured for suspension growth of fish larvae and probiotics; and
2) building a dual-drain recirculating water treatment system, the dual-drain recirculating water treatment system comprising the first water treatment system and the second water treatment system respectively disposed on both sides of the nursery tank, respectively.

16. The method of claim 15, wherein in 1), building the nursery tank comprises:
1.1) choosing a rounded corner tank or a polygonal tank without right angles as the nursery tank, wherein the nursery tank has an area of 10-50 m², and the nursery tank contains water in a depth range of 0.8-1.5 m;
1.2) disposing a second drain window on the bottom of the nursery tank, and disposing the standing mesh drain pipe comprising a 40-80 mesh screen in the center of the bottom of the nursery tank, the standing mesh drain pipe communicating with the second drain window;
1.3) disposing the first aerotube around the bottom of the inner wall of the nursery tank; and
1.4) disposing a first water pipe and a second water pipe at two opposite corners of the nursery tank and above a water level of the nursery tank, respectively, connecting the first water pipe to a first outlet of the first water treatment system, and connecting the second water pipe to a second outlet of the second water treatment system, such that the two-way water treatment system continuously supplies high-quality clean water for the nursery tank.

17. The method of claim 16, wherein:
disposing the first water treatment system comprises:
2.1.1) disposing a first filter net cage to communicate with an inlet of the first filtering basin to filter the upper layer water from the nursery tank; precipitating solid wastes of the upper layer water at the bottom of the first filter net cage, and allowing the clean water to enter the first biological filtering basin;
2.1.2) disposing a second aerotube at the bottom around the wall of the first biological filtering basin, and disposing a plurality of first biological filtration brushes vertically up and down in the first biological filtering basin;
2.1.3) disposing a first airlift pump in the first water reservoir; storing the upper layer water filtered through the first biological filtering basin in the first water reservoir and pumping into the nursery tank by the first airlift pump, to provide high-quality purified water for fish larvae; wherein, the first airlift pump is a nano-tubular airlift pump comprising a first PVC tube with an inner diameter of 60 to 100 mm and a fourth aerotube with a length of 200 to 800 mm disposed inside the first PVC tube; one end of the fourth aerotube is blocked and the other end is connected to an air tube equipped with a valve and connected to a blower; and
2.1.4) inflating the fourth aerotube to produce microbubbles, allowing the microbubbles to flow along with the upper layer water out of the first PVC tube and enter the nursery tank;
disposing the second water treatment system comprises:
2.2.1) disposing a second filter net cage to communicate with an inlet of the second filtering basin to filter the lower layer water from the nursery tank; precipitating the solid wastes of the lower layer water at the bottom of the second filter net cage, and allowing the clean water to enter the second biological filtering basin;
2.2.2) disposing a third aerotube at the bottom around the wall of the second biological filtering basin, and disposing a plurality of second biological filtration brushes vertically up and down in the second biological filtering basin;
2.2.3) disposing a second airlift pump in the second water reservoir; storing the lower layer water filtered through the second biological filtering basin in the second water reservoir and pumping into the nursery tank by the second airlift pump, to provide high-quality purified water for fish larvae; and
2.2.4) inflating the second airlift pump to produce microbubbles, allowing the microbubbles to flow along with the lower layer water and enter the nursery tank.
